(19) United States
(12) Patent Application Publication
(10) Pub. No.: US 2022/0093075 A1
(43) Pub. Date: Mar. 24, 2022

(54) AUDIO ENHANCEMENT AND NOISE CANCELLING SYSTEMS AND METHODS

(71) Applicant: SALVATORE GUERRIERI, Lavallette, NJ (US)

(72) Inventor: SALVATORE GUERRIERI, Lavallette, NJ (US)

(21) Appl. No.: 17/480,003

(22) Filed: Sep. 20, 2021

Related U.S. Application Data
(60) Provisional application No. 63/081,064, filed on Sep. 21, 2020.

(51) Int. Cl. G10K 11/178

(52) U.S. Cl. CPC G10K 11/1785; H04M 1/725; G10K 2210/3012; G10K 2210/108

(57) ABSTRACT

An aspect of the present invention relates to an active noise cancelling or an active noise gating system that applies an algorithm for reducing ambient noise. The active noise cancelling system may be used to cancel undesired background noise but for an audio signal which is desired to be heard by the user. The present invention acts as a noise gate, wherein the algorithm(s) actively senses ambient noise levels and the algorithm stored in system memory instructs the device to mute a microphone at or above certain preset noise levels. The preset levels in which the system may mute background noise may be applied by the user using a slide bar that the user may manually adjust to apply more or less noise gating

### RELATED APPLICATION

This application claims priority from U.S. provisional application Ser. No. 63/081,064 filed Sep. 21, 2020, the contents of which are hereby incorporated by reference in its entirety.

### TECHNICAL FIELD

The present invention relates generally to audio enhancement and noise cancelling systems, and in particular to noise cancelling systems which actively senses and operates to reduce undesired ambient background noise for a user.

### BACKGROUND

Previous approaches to cancel noise in a known predefined space by sensing the noise with sensors placed at known parts in the area and producing an audio signal of the same magnitude and 130 degrees out of phase with the noise to cancel the noise (see in particular patent publication WO89/11841). However, the processing involved in such a noise cancellation system is extremely complex and can only be designed to cancel synchronous, repetitive background noise and not intermittent noise which does not occur at regular intervals. This intermittent noise will still be heard by the user. Another example of disclosure relating to the cancellation of repetitive noise is given in Australian patent application number AU 85255/82.

It is known to provide Active Noise Cancelling (ANC) by providing a microphone to sense ambient noise and an earphone placed m the vicinity of the microphone to produce a noise cancelling acoustic signal. However, such a noise cancelling system is only effective over very narrow frequency ranges. Noise falling outside the effective frequency range of the system will still be a problem. For, example, patent to Olsen (1953) discloses such a system. A microphone placed near the user's ear detects noise and is used to electrically drive an earphone loudspeaker. 3y increasing the electronic gain in the cancellation loop a frequency is found where the loudspeaker audio signal is equal in magnitude and opposite, in phase with the external noise, pressure wave at the listener's ear, causing attenuation of the noise. This electromechanical phenomenon is commonly known as “Active Noise Control” (ANC). Unfortunately, it is only effective over a narrow frequency range, as discussed above. This range is too narrow to cause sufficient attenuation of noise over a satisfactory range for most practical applications.

### SUMMARY OF THE PRESENT INVENTION

An aspect of the present invention relates to an active noise cancelling or an active noise gating system that applies an algorithm for reducing ambient noise. The active noise cancelling system may be used to cancel undesired background noise but for an audio signal which is desired to be heard by the user. The present invention acts as a noise gate, wherein the algorithm is) actively senses ambient noise levels and the algorithm stored in system memory instructs the device to mute a microphone at or above certain preset noise levels. The preset levels in which the system may mute background noise may be applied by the user using a slide bar that the user may manually adjust to apply more or less noise gating. For example, if the user's slide bar is set to 50, this level may mute the microphone for any noise above 65 decibels (typical ambient noise). If the slide bar is set to 100, all background noise including the user's conversation may be muted.

Another aspect of the present invention is call enhancement, where the compression ratio of the user's voice may be enhanced. For example, the compression ratio determines how much gain reduction the compressor applies when the signal passes a threshold level. For example, a ratio of 4:1 means that for every 4 dB the signal rises above the threshold, the compressor will increase the output by 1 dB.

The present invention may be used in a communication system (e.g., telephone network) to provide electronic attenuation of ambient noise being received at an input microphone to the communication system (e.g., telephone mouthpiece).

Accordingly, there is a need for an active noise attenuation system that is effective over a wide audio range.

There is also a need for telephone call enhancement while providing for active noise attenuation.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 shows an illustrative schematic diagram of a signal noise attenuation system that may be used to implement aspects of the present invention.

FIG. 2 show illustrative graphs in accordance with an embodiment if the present invention

### DETAILED DESCRIPTION

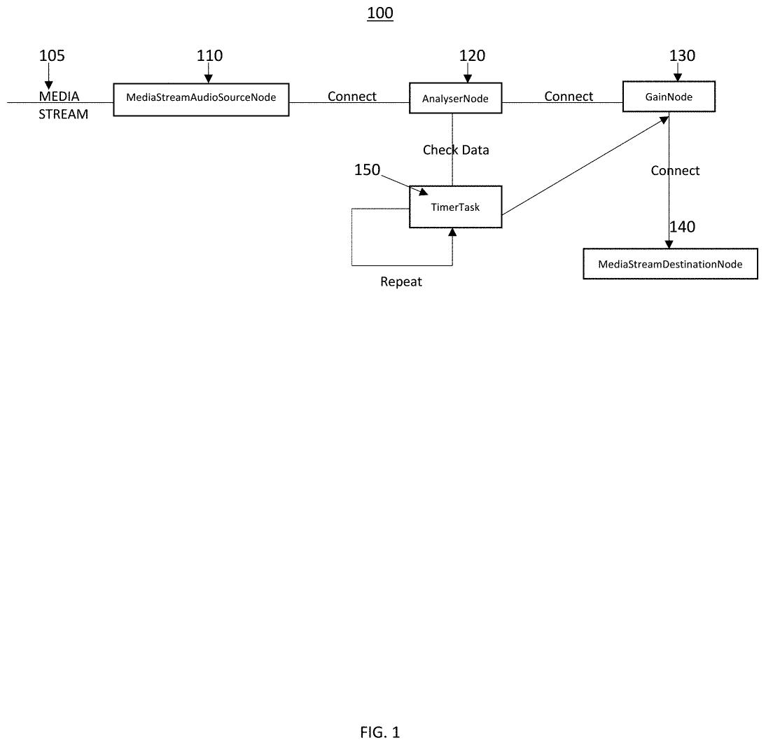

FIG. 1 shows a schematic diagram of a system according to the present invention. FIG. 1 shows system 100 that may include a AudioContext interface (not Shown in FIG. 1) and represents an audio-processing graph built from audio modules/nodes linked together. Examples of audio modules/nodes linked together, in the present invention, may include MediaStreamAudioSourceNode, AnalyzerNode, GainNode, and MediaStreamAudioDestinationNode. MediaStreamAudioSourceNode, AnalyzerNode, GainNode, and MediaStreamAudioDestinationNode. AudioContext may control both the creation of the modules/nodes that it may contain and the execution of the audio processing or decoding.

In operation, FIG. 1 shows an incoming MediaStream 105 which may, for example, be one or more signals from a microphone, a speaker, or any other device that may be used to send and/or receive a signal (e.g., an audio signal that may include background or any other form signal distortion in this case). MediaStream 105 may be the input for MediaStreamAudioSourceNode 110. MediaStreamAudioSourceNode 110 is a type of AudioNode that operates as an audio source whose media is received from MediaStream 105 and may be obtained using any suitable means, for example, WebRTC¹ or Media Capture and Streams APIs², and/or Bluetooth. MediaStreamAudioSourceNode 110 receives a signal that may, for example, be a signal from a microphone, a speaker, or any other device that may be used to send and/or receive a signal (e.g., an audio signal that may include background or any other form signal distortion to the audio signal in this case). One Skilled in the art will appreciate that any node described herein may further include, if desired, to add a compressor, a limiter, a harmonizer, a reverb, a delay, and/or any type of signal enhancement device. ¹A WebRTC application will usually go through a common application flow. Accessing the media devices, opening peer connections, discovering peers, and start streaming.²The Streams API allows JavaScript to programmatically access streams of data received over the network and process them as desired by the developer.

Next, system 100 may include an AnalyzerNode 120 that may be electrically, fiber optically, and/or use any other suitable connection method (e.g., connected via a software connection, Bluetooth, etc.) to MediaStreamAudioSourceNode 110. AnalyzerNode 120 may represent a node able to provide real-time frequency and time-domain analysis information on one or more media stream(s) 105 simultaneously or independently from each other. For example, two media steams enter the MediaStreamAudioSourceNode 110 and these streams may be analyzed simultaneously or independently from each other (i.e., real-time analysis of the frequency and time-domain information). For example, a streaming media platform may be playing background music while a video call is coming in, the user and/or the system may control the signals so that the incoming call may be heard more clearly than the background music. In other words, if a volume A is set to a certain level and a user begins speaking, volume A may automatically or manually be decreased in volume in order for the user to hear volume B more clearly. In the previous example we are discussing volume, but it should also be understood that gain, compression, and/or equalization may performed in the same manner, on the same signal(s), at the same time. AnalyzerNode 120 may be an AudioNode that passes the audio stream(s) unchanged from the input to the output, but allows you to take the generated data, process it, and create audio visualizations of the media stream(S) 105. AnalyserNode may have one input and one output or a plurality of inputs and outputs. The node works even if the output is not connected. AnalyserNode 120 with “FFTSize” property set to any value with a range between 32 to 32768, and a preferred value of 512 and a “SmoothingTimeConstant” property set to any value with a range between 0 and 1, and a preferred value of 0.3 The FFTSize and the SmoothingTimeConstant values may be changed by the user and/or automatically to adjust/modify/enhance the signal.

Next, AnalyzerNode 120 may be connected to GainNode 130. GainNode 130 may be electrically, fiber optically, and/or any other suitable connection method (e.g., connected via a software connection) to AnalyzerNode 120 and MediaStreamAudioDestinationNode 140. Gain Node 130 may be used adjust the output signal of the initial media stream.

As mentioned above, GainNode 130 may be electrically, fiber optically, and/or any other suitable connection method (e.g., connected via a software connection) to MediaStreamAudioDestinationNode 140. MediaStreamAudioDestinationNode 140 may generate an output media stream that may be sent to another device. For example, MediaStreamAudioDestinationNode 140 may generate and output a media stream to other participants on a telephone call to enhance the users call.

After the AudioContext nodes are created and connected to each other, a TimerTask 150 may be started. TimerTask 150 may every 20 milliseconds check the data from AnalyserNode 120 (analyser.getFloatFrequencyData). Those skilled in the art will appreciate that if the maximum value of the decibel data from Analyzernode 120 is below the provided Audio threshold and the audio source (e.g., a Microphone) is not muted—the audio source gets marked for muting. If after 600 ms the maximum set value from Analysernode 120 is still under a defined threshold value, then the Audio Source (i.e., the Microphone) gets muted. However, if the value is above a defined threshold value and the Microphone is muted, then the Microphone gets unmuted. The threshold values may be manually changed by the user in real time on a live feed. The present invention sets a “white-noise” minimum by default at −65 Decibels. The maximum and minimum threshold values can be programmed to any minimum or maximum.

As set forth in detail above, the present invention's advanced background noise cancelling/attenuation technology allows the user to set the level that the user's device mutes and unmutes a microphone automatically above and below certain sound thresholds. The user may manually adjust this threshold setting for more or less noise cancellation by moving a slider or a dial up or down from 0-100 depending on the user's individual needs.

The default for the present invention may be set at 65 decibels (typical normal background noise levels), which means the default setting may reduce most background noise automatically (i.e., when a telephone call is initiated). The system may visually show the user an audio meter level so that the user may manually apply more noise cancelling or reduce the amount of noise cancelling as desired.

Another aspect of the present invention in order to further enhance the quality of the user's call a dynamic range compression (DRC) may be processed to the audio input, hence, making the users voice clearer and fuller to the listener on the other side. DRC is an audio signal processing operation that reduces the volume of loud sounds or amplifies quiet sounds thus reducing or compressing an audio signal's dynamic range.

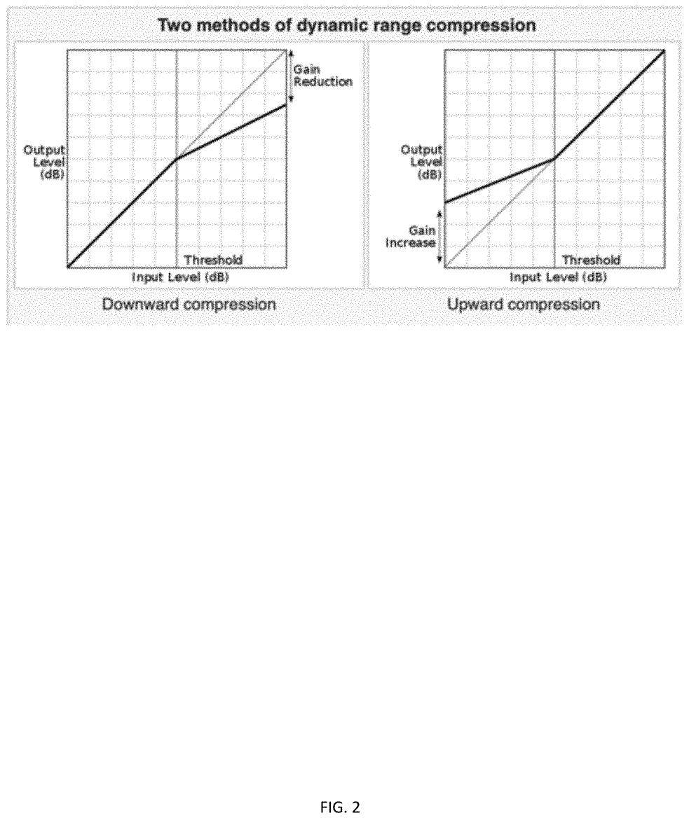

DRC may be set by the user using a slider bar, for example, the slider bar for DRC may also be from 0-100, where the where 0 may indicate that no DRC is being used to enhance the call and 100 may be where DRC is in its maximum state. For example, the system may use downward compression that reduces loud sounds over a certain threshold while quiet sounds remain unaffected. The system may also employ upward compression that increases the loudness of sounds below a certain threshold while leaving louder sounds unaffected. See FIG. 2.

The present invention may be implemented by combining one or more algorithms on what normal background noise levels are and what speaking voice levels are. The present invention may employ one or more algorithms on different background noises levels and acts accordingly, creating a seamless, automated, naturally sounding noise gate. For example, the present invention may employ an algorithm as follows:

```
The AnalyserNode API for calculating the microphone sound level:
    this.analyser = audioContext.createAnalyser ( );
    this.analyser.fftSize = 512;
    this.analyser.smoothingTimeConstant = 0.3;
    this.dataArray = new
    Float32Array(this.analyser.frequencyBinCount);
  On every 20 ms we check if the volume is above or under the
  threshold. And mute or un-mute the microphone:
    tick = ( ) => {
      this.ticker = setTimeout ( ( ) => {
this.analyser.getFloatFrequencyData
(this.dataArray); const max =
  Math.max(. . . this.dataArray);
        if (max < this.audioGateThreshold &&
        this._micGainNode.gain.value === 1) {
          // If max value is below the threshold and if
          gainNode not 0 we mute
          this._micGainNode.gain.value = 0;
        } else if (max >= this.audioGateThreshold &&
        this._micGainNode.gain.value === 0) {
          // If max value is above or equal to the threshold and
          if gainNode not 1 we un-mute
          this._micGainNode.gain.value = 1;
        }
        this.tick ( );
      }, 20);
    }
End code,
  this.source =
  audioContext.createMediaStreamSource(mediaStream);
    this.source.connect(this.analyser);
    this.analyser.connect(this._mi GainNode);
```

It will be understood that the system described herein is merely an illustrative embodiment and is not meant to be comprehensive or necessarily performed in the order discussed herein. Persons skilled in the art will appreciate that the present invention can be practiced by other than the described embodiments, which are presented for purposes of illustration rather than of limitation, and the present invention is limited only by the claims which follow.

What is claimed is:

1. A system for enhancing the quality of a signal comprising:
a device capable of sending and receiving an signals;
a processor for processing signals;
a microphone;
a speaker; and
a memory device containing at least one noise gating algorithm, and wherein the memory device also uses at least one dynamic range compression algorithms that allows the compression range of the audio signal to be modified;
Wherein the noise gating algorithm and the dynamic range compression algorithm may be manually adjusted to adjust and select the desired amount of noise attenuation and compression.

2. The system of claim 1, wherein a media stream is sent to a communications input and output device.

3. The system of claim 1, includes a plurality of noise gating and compression algorithms.

4. The system of claim 1, wherein the memory device includes software that includes a MediaStreamAudioSourceNode, an AnalyzerNode, a GainNode, a MediaStreamAudioDestinationNode, and TimerTask.

5. The system of claim 1, wherein the compression algorithm levels are preset.

6. The system of claim 1, wherein the compression algorithm levels are set manually.

7. The system of claim 1, wherein the compression algorithm levels are set automatically.

8. The system of claim 2, wherein the communications input and output device is a mobile phone.

9. The system of claim 2, wherein the communications input and output device is a computer.

10. A system for enhancing the quality of an audio signal comprising:
a device capable of sending and receiving an audio signals;
a processor for processing audio signals;
a microphone;
a speaker; and
a memory device containing at least one noise gating algorithm/and wherein the memory device also uses at least one dynamic range compression algorithms that allows the compression range of the audio signal to be modified;
Wherein the noise gating algorithm and the dynamic range compression algorithm may be manually adjusted to adjust and select the desired amount of noise attenuation and compression.

11. The system of claim 10, wherein a media stream is sent to a communications input and output device.

12. The system of claim 10, includes a plurality of noise gating and compression algorithms.

13. The system of claim 10, wherein the memory device includes software that includes a MediaStreamAudioSourceNode, an AnalyzerNode, a GainNode, a MediaStreamAudioDestinationNode, and TimerTask.

14. The system of claim 10, wherein the compression algorithm levels are preset.

15. The system of claim 10, wherein the compression algorithm levels are set manually.

16. The system of claim 10, wherein the compression algorithm levels are set automatically.

17. The system of claim 11, wherein the communications input and output device is a mobile phone.

18. The system of claim 11, wherein the communications input and output device is a computer.

19. A system for enhancing the quality of a plurality of signals comprising:
a mobile device capable of sending and receiving a plurality of signals;
a processor for processing a plurality of signals within a mobile device;
a microphone;
a speaker; and
a memory device containing at least one noise gating algorithm, and wherein the memory device also uses a plurality of dynamic range compression algorithm that allows the compression range of the signal to be manually modified;
Wherein the noise gating algorithm and the dynamic range compression algorithm are manually adjusted to adjust and select the desired amount of noise attenuation and compression, and wherein the plurality noise gating algorithms and the at least one dynamic range compression algorithms manual settings are between 32 to 32768 for an FFTsize and a SmoothingTimeConstant between 0 and 1.

20. The system of claim 19, wherein the plurality of noise gating algorithms and dynamic range compression algorithms manual settings are 512 for an FFTsize and a SmoothingTimeConstant of 0.3.
